(19) United States
(12) Patent Application Publication
(10) Pub. No.: US 2024/0327250 A1
(43) Pub. Date: Oct. 3, 2024

(54) DEVICE FOR TREATING AQUEOUS EFFLUENT BY MEANS OF FILTRATION, UV AND OZONE, AND METHOD USING SUCH A DEVICE

(71) Applicant: Nicolas MEUDAL, Pleubian (FR)

(72) Inventor: Nicolas MEUDAL, Pleubian (FR)

(21) Appl. No.: 18/744,224

(22) Filed: Jun. 14, 2024

Related U.S. Application Data
(63) Continuation-in-part of application No. PCT/EP2022/085763, filed on Dec. 14, 2022.

(30) Foreign Application Priority Data
Dec. 16, 2021 (FR) 2113746

(51) Int. Cl. C02F 1/32; C02F 1/00; C02F 1/72; C02F 1/78

(52) U.S. Cl. CPC C02F 1/325; C02F 1/004; C02F 1/725; C02F 1/78; C02F 2201/007; C02F 2201/3225; C02F 2201/3227; C02F 2201/3228; C02F 2201/782; C02F 2303/04; C02F 2305/10

(57) ABSTRACT

Device for treating aqueous effluents comprising:
A tank,
A rotary filter arranged in the tank to carry out an aqueous effluent filtration operation,
At least one UV lamp disposed in the tank so as to be immersed in the filtered aqueous effluent,
At least one catalyst element arranged to be illuminated by the UV lamp and fixed in the tank so as to be immersed in the aqueous effluents and/or fixed on the rotary filter.

### CROSS-REFERENCE TO RELATED APPLICATIONS

This application is a continuation-in-part and claims priority to International Application No. PCT/EP2022/085763, filed Dec. 14, 2022, entitled “DEVICE FOR TREATING AQUEOUS EFFLUENT BY MEANS OF FILTRATION, UV AND OZONE, AND METHOD USING SUCH A DEVICE,” which claims priority to France Application No. 2113746 filed with the France Patent Office on Dec. 16, 2021, all of which are incorporated herein by reference in their entirety for all purposes.

The treatment of liquid effluents or wastewater from human activities has become a subject of concern for authorities and citizens for several decades. Numerous standards and regulations now prevent the discharge of these effluents into the environment without any treatment.

Devices for treating aqueous effluents are known in the prior art in which the aqueous effluents are treated by ozone, by UV light and by filtration. For example, document CN107930235A describes an example of a device comprising an ozonation reactor and a drum filter equipped with UV lamps.

On the other hand, this device has the particular disadvantage of requiring an expensive and large installation with several aqueous effluent treatment elements. Furthermore, the operating costs of such a device are high due to the numerous electrical systems required, including the ozone dosing system.

An object of the present description is to overcome the disadvantages of the prior art mentioned above and in particular to propose a device for treating aqueous effluents which is compact and inexpensive to be manufactured, deployed and operated.

For this purpose, an object of the present description relates to an aqueous effluent treatment device comprising:
A tank,
A rotary filter arranged in the tank to carry out an aqueous effluent filtration operation,
At least one UV lamp disposed in the tank so as to be immersed in the filtered aqueous effluent,
At least one catalyst element comprising for example a photocatalyst element such as titanium oxide or zinc oxide, arranged to be illuminated by the UV lamp and fixed in the tank so as to be immersed in the aqueous effluents and/or fixed on the rotary filter.

UV illumination allows to disinfect the aqueous effluent filtered by the rotary filter as well as the surface of the rotary filter. Furthermore, the ozone generated by the illumination of the catalyst element helps to limit clogging or fouling of the rotary filter and to disinfect the filtered aqueous effluents. Such an aqueous effluent treatment device allows inexpensive construction and also inexpensive operation, in particular by optimizing the electrical power consumed by the UV lamps.

Preferably, no UV lamp is housed inside the rotary filter. Furthermore, such a device for treating aqueous effluent allows to avoid the provision of any disinfection element or equipment upstream or downstream of the rotary filter. In particular, the provision of one or more other devices for disinfecting aqueous effluents which may involve UV light and/or ozone can be avoided.

Advantageously, the at least one catalyst element comprises an immovable catalyst element disposed in the tank, preferably between the UV lamp and a wall of the tank, for example under the at least one UV lamp. Such an arrangement allows to simply optimize the use of the UV light emitted by the UV lamp.

Advantageously, the at least one catalyst element comprises at least one movable catalyst element disposed on the rotary filter. Such a movable catalyst element is especially suitable when the rotary filter is rotated sequentially. For example, a plurality of movable catalyst elements are disposed on the rotary filter so that at least one catalyst element is always illuminated by a UV lamp, regardless of the position of the rotary filter. Alternatively or in combination, the catalyst element can be integrated into a filtration surface of the rotary filter. Such a movable catalyst element allows the generation of ozone as close as possible to a filtration surface of the rotary filter, which limits clogging of the rotary filter.

Advantageously, the treatment device further comprises at least one outlet portion of the treated aqueous effluents, the at least one UV lamp and/or the at least one catalyst element being arranged or fixed in the tank on the side of the outlet portion. This arrangement of the at least one UV lamp and/or the at least one catalyst element facing the at least one outlet portion, that is to say in the flow of treated aqueous effluents leaving the tank, allows greater effectiveness of the aforementioned disinfectant effect. For example, the at least one UV lamp and/or the at least one catalyst element are only disposed on the side of the outlet portion.

Advantageously, the at least one outlet portion is disposed on an edge of the tank, on an axis parallel to the axis of rotation of the rotary filter. Such an arrangement allows to optimize the disinfection of the flow of filtered liquid effluents while simplifying the construction of the present treatment device. For example, the at least one UV lamp may comprise one or more UV lamps in the form of tubes, which can be disposed parallel to the outlet portion, that is to say parallel to the axis of rotation of the rotary filter.

Advantageously, the treatment device comprises a single outlet portion and the rotary filter is arranged in the tank so that a portion of the rotary filter enters the aqueous effluents on the side of the outlet portion when the rotary filter is rotating in the tank. Such a treatment device can also be disposed in a limited space, for example against a wall, while maintaining a high level of treatment of aqueous effluents.

Advantageously, the rotary filter is arranged to be rotated sequentially. Such an arrangement allows limitation of clogging by maximizing the exposure of the filtration surface of the rotary filter to UV light and ozone.

Advantageously, the rotary filter is a drum filter or a disc filter or a screen filter.

Another aspect of the present description relates to a method for treating aqueous effluents by means of a treatment device comprising a tank, a rotary filter, at least one UV lamp arranged to be immersed in the aqueous effluents and at least one catalyst element including titanium oxide, the method comprising the following steps:
a) supplying aqueous effluents to an interior of the rotary filter,
b) rotating the rotary filter,
c) illuminating the filtered aqueous effluents by the at least one UV lamp,
d) generating ozone in the filtered aqueous effluents by the illumination of the at least one catalyst element by the at least one UV lamp.

Advantageously, the at least one catalyst element comprises at least two movable catalyst elements placed on the rotary filter, and the step of rotating the rotary filter is carried out sequentially by alternating a mobile phase and a stationary phase, so that at least one of the movable catalyst elements is always immersed and illuminated in the filtered aqueous effluent. Such a method allows to optimize the manufacturing and installation costs of the treatment device while maintaining a high level of treatment of aqueous effluents.

Other characteristics and advantages of the present description will appear more clearly upon reading the detailed description which follows of embodiments given by way of non-limiting examples and illustrated by the appended drawings, in which:

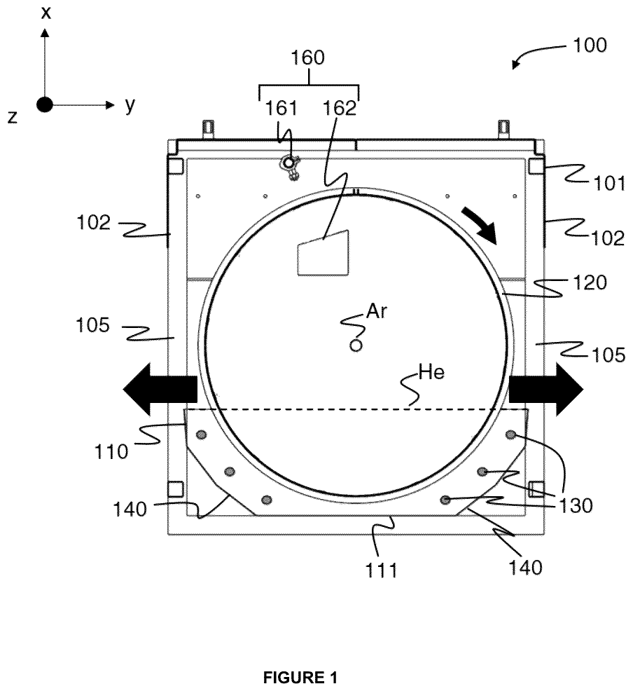

FIG. 1 is a rear sectional view of an aqueous effluent treatment device according to one embodiment of the present description.

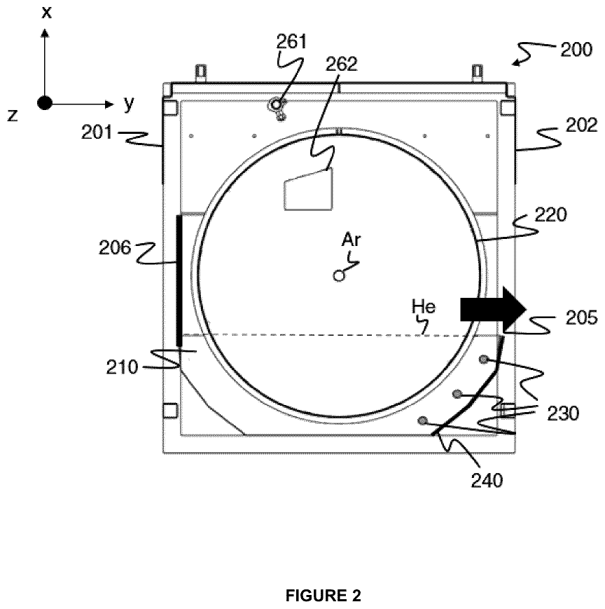

FIG. 2 is a rear sectional view of an aqueous effluent treatment device according to a second embodiment of the present description.

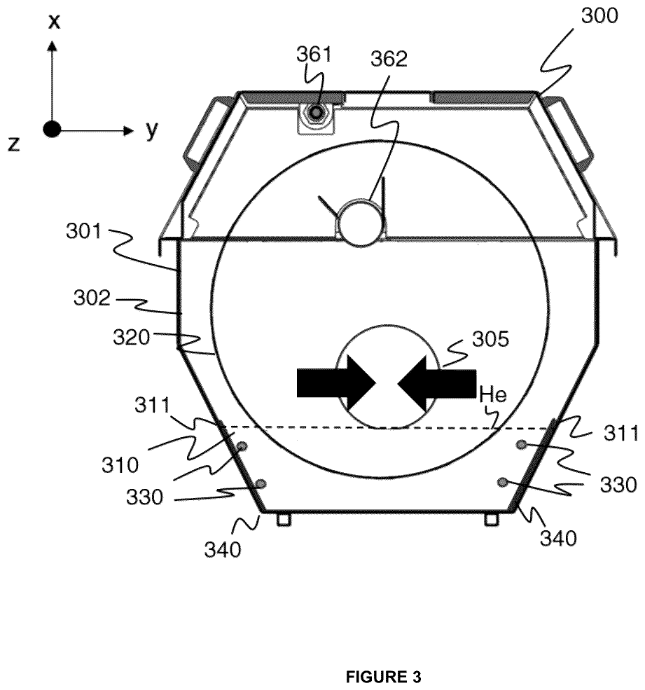

FIG. 3 is a rear sectional view of an aqueous effluent treatment device according to a third embodiment of the present description.

The object of this description is an aqueous effluent treatment device for treating residential, agricultural, aquaculture and/or industrial aqueous effluents, in other words drinking water or waste water. These aqueous effluents may comprise all types of organic or nitrogenous materials, bacteria, viruses, micropollutants such as microplastics as well as pharmaceutical and/or chemical residues.

In the context of this description, the aqueous effluents can be treated by filtration, by exposure to UV light and by exposure to ozone so as to obtain treated aqueous effluents, for example suitable for reuse or discharge in the environment.

FIG. 1 represents a first embodiment of the present description comprising an aqueous effluent treatment device 100 comprising a frame 101, for example of square section defining a tank 110 in its lower part and a rotary filter 120 in the form of a drum filter arranged to be rotated in the tank 110. The drum filter 120 comprises a wall provided at least partially with a filtration element, for example a cloth or a perforated element, as known to the person skilled in the art.

The aqueous effluents to be treated can be preferentially introduced into an interior space of the drum filter 120 so as to pass through the filtration element from the inside to the outside of the drum filter 120. For example, a simple feed inlet (not shown) can be provided on a wall portion of the tank 110 or the frame 101 opening onto an interior space of the drum filter 120. Alternatively or in combination, an aqueous effluent supply ramp (not shown) can be provided over part or all of the length of the drum filter 120 (along the axis z in FIG. 1).

Preferably, the drum filter 120 can be rotated along an axis of rotation Ar horizontal or parallel to the ground and/or to a bottom portion 111 of the tank 110, for example in the clockwise direction represented by the rounded arrow in FIG. 1. Furthermore, the axis of rotation Ar of the drum filter 120 can be placed on a plane of symmetry of the tank 110 and/or the frame 101. The axis of rotation Ar can also be merged with an axis of symmetry of the frame 101, so as to limit the bulk of the treatment device 100.

The frame 101 may comprise two outlet portions 105 located for example on side walls 102 of the frame 101 and/or on either side of the drum filter 120 and allowing evacuation of the treated aqueous effluent according to the horizontal arrows visible on FIG. 1. These outlet portions 105 can extend over the entire length of the tank 110 (along the axis z of FIG. 1) or at least over a significant part of this length, for example at least 50%, preferably at least 75% and more preferably at least 85%.

A height of the tank 110 and/or a minimum height of the aqueous effluent He in the tank 110 in operation can thus be limited by a height of the outlet portion 105 relative to the wall or bottom portion 111 of the tank 110 (along the axis x of FIG. 1). Preferably, the tank 110 does not comprise other outlet portions or orifices for aqueous effluents. Removable flaps (not shown) can be provided to close the outlet portions 105, for example in a storage or transport configuration of the treatment device 100 or to adapt the minimum height He of the aqueous effluents.

One or more UV lamps 130 are disposed in the tank so as to be immersed in the aqueous effluents, for example closer to the bottom portion 111 of the tank 110 than to a median plane along the axis x of the frame 101 and below the height of aqueous effluents when the treatment device 100 is in operation. The UV lamps can be disposed on either side of the drum filter 120, preferably in an arc of a circle parallel to the filtering surface of the drum filter 120.

These UV lamps 130 are for example in the form of tubes extending over the entire length of the tank 110 or the drum filter 120 (along the axis z of FIG. 1) or over a significant part of this length, for example at least 50%, preferably at least 75% and more preferably at least 85%. The length of the tubes of the UV lamps 130 can correspond to the length of the outlet portions 105. The UV lamps 130 can emit UV light, for example UV-C light, in all directions, that is to say also towards the drum filter 120 and towards the walls of the tank 110. The UV lamps can be mercury lamps such as amalgam lamps, low pressure lamps, medium pressure lamps or else be based on semiconductor light sources, such as LEDs, laser diodes, superluminescent diodes.

Furthermore, at least one and preferably several catalyst elements 140 can be disposed in the tank 110, these catalyst elements 140 comprising titanium oxide TiO₂. For example, these elements can form side walls of the tank 110, thus limiting the volume of the tank 110. Alternatively, the catalyst elements can simply be disposed in the tank 110 without limiting its volume. The catalyst elements 140 can be fixed or movably mounted in the tank 120. The catalyst may be a catalyst producing ozone upon UV illumination in water, preferably an oxide of a transition metal such as titanium oxide or zinc oxide. Titanium oxide can be inserted in a layer, in a paint, directly in the mass of the catalyst element or form the catalyst element. In addition, zinc oxide (ZnO) can also be used as a catalyst element 140. ZnO, like TiO₂, possesses effective photocatalytic properties under UV irradiation, making it suitable for aqueous effluent treatment applications. Studies have shown that ZnO is a viable alternative photocatalyst to TiO₂, with similar ozone generation and pollutant degradation properties.

The catalytic elements can each be disposed at an equal distance from a UV lamp 130. Preferably, the catalytic elements can be disposed between the frame 101 and the UV lamps 130, that is to say on one side of each UV lamp 130 opposite the drum filter 120. It is thus not preferable that the catalytic elements 140 or even other light deflecting elements are disposed between the UV lamps 130 and the drum filter 120. The catalytic elements 140 can for example have a flat or curved section so as to reflect the light of the UV lamps 130 towards the drum filter 120.

The tank 110 or the lower portion of the frame 101 comprises two opposite side portions each comprising a right angle in FIG. 1, for example on either side of a longitudinal axis of the tank 110 or of the frame 101 or of a vertical median plane (along the axes y and z). The UV lamps 130 and/or the catalyst elements 140 can be disposed exclusively in these side portions. These side portions can each occupy from ⅙ to ⅓ or ½ of the width of the tank 110 or the frame 101, for example along the axis y in FIG. 1. These side portions can be under the outlet portions 105 and/or opposite the outlet portions 105.

A system 160 for cleaning the drum filter 120 may comprise one or more water nozzles 161, for example at high pressure, and a sludge collection ramp 162 disposed in the axis of the water jet leaving the nozzle 161.

Finally, the frame 101 can be provided with connection elements, such as hooks, orifices or indentations, allowing its handling and transport. For example, the frame 101 has the dimensions of a standard container, for example a maritime container, or has dimensions allowing it to be housed in such a container.

In addition, the frame 101 can contain the electrical systems allowing to ensure treatment of the aqueous effluents, such as an electric motor to rotate the drum filter 120, one or more pumps or else one or more level sensors for the aqueous effluents, one or more flow sensors, pH sensors, and any other element for monitoring or controlling such a treatment device known to the person skilled in the art.

In operation, aqueous effluents to be treated are introduced inside the drum filter 120, and the drum filter 120 is rotated, for example in the clockwise direction as shown in FIG. 1. The drum filter 120 can be rotated as soon as a minimum level He of aqueous effluent in the tank is reached.

The sludge thus remains on the interior wall of the drum filter 120, while the filtered aqueous effluents or clear water pass through the drum filter 120 and remain in the tank 110. In the tank 110, the UV-C light emitted by UV lamps 130 allow both to disinfect the filtered aqueous effluents by destroying at least partially bacteria, germs and viruses in suspension, but also to limit the clogging of the drum filter 120 by limiting the bacterial proliferation which can clutter the filtration surface of the drum filter 120.

Furthermore, the UV-C light emitted by the UV lamps 130 towards the catalyst elements 140 allows to generate ozone O₃ in the filtered aqueous effluents, which reinforces and completes the disinfection of the filtered effluents carried out directly by UV-C light and also contributes to limiting the clogging of the drum filter 120. These catalytic elements therefore allow to optimize the disinfectant and anti-clogging effects of the UV lamps without increasing the electrical power consumed, that is to say by making best use of the UV light emitted.

FIG. 2 represents a second embodiment close to the first embodiment. According to this second embodiment, an aqueous effluent treatment device 200 comprises a frame 201, a tank 210 and a rotary filter in the form of a drum filter 220 identical to FIG. 1.

Unlike FIG. 1, one of the outlet portions 205 is non-existent or else closed by a shutter or a sealed closing plate 206, preventing the evacuation of the treated aqueous effluent on one side of the drum filter 220. Thus, only one outlet portion 205 is available, for example on a single side wall 202.

The UV lamps 230 and the catalyst element(s) 240 are thus located in a single side portion of the tank 210 or the frame 201, only on the side of the outlet portion 205. Such a device 200 for treating aqueous effluent allows to achieve effective treatment of aqueous effluents while limiting its size. For example, such a treatment device can be placed against a wall. Furthermore, the installation and operating costs are reduced, particularly if the volume of aqueous effluents is moderate.

FIG. 3 represents a third embodiment of the present description, including an aqueous effluent treatment device 300 with a shape different from the first and second embodiment.

In particular, the frame 301 has a lower portion of trapezoidal shape and a tank 310 of the same shape. In this embodiment, the UV lamps 330 are disposed along the side or oblique walls 311 of the tank 310, these side or oblique walls 311 each being further provided with one or more catalyst elements 340.

The treatment device 300 further comprises a pipe or outlet portion 305 of the treated aqueous effluents located not on a side wall 302 of the frame 301, but on a transverse wall not visible in the sectional view of FIG. 3, for example extending along the axes x and y of FIG. 3.

The technical characteristics of the three embodiments described above can be exchanged. For example, the outlet portion 305 can be used in the first and second embodiments.

Furthermore, the tank is not limited to a tank integrated into a frame, but can also comprise a tank separate from the frame, for example a concrete tank receiving the frame and the drum filter. The rotary filter according to the present description is not limited to a drum filter, but can also comprise a disc filter or a screen filter.

The filtration element comprising titanium dioxide is preferably placed facing the UV lamps and opposite the rotary filter with respect to the UV lamps. However, it can also be placed on the rotary filter, for example between the filtration surfaces and/or integrated into the filtration surfaces. For example, a filter cloth or wall can be provided with titanium dioxide particles deposited or inserted into the mass of the material.

In the case of sequential rotation of the rotary filter, for example quarter by quarter, these catalytic elements can be disposed so that at least one element is always immersed and illuminated by one or more UV lamps.

1. A device for treating aqueous effluents comprising:
A tank,
A rotary filter arranged in the tank to carry out an aqueous effluent filtration operation,
At least one UV lamp disposed in the tank so as to be immersed in the filtered aqueous effluent,
At least one catalyst element arranged to be illuminated by the UV lamp and fixed in the tank so as to be immersed in the aqueous effluents and/or fixed on the rotary filter.

2. The aqueous effluent treatment device according to claim 1, wherein the at least one catalyst element comprises titanium oxide and/or zinc oxide.

3. The aqueous effluent treatment device according to claim 1, wherein the at least one catalyst element comprises an immovable catalyst element disposed in the tank, between the at least one UV lamp and a wall of the tank.

4. The aqueous effluent treatment device according to claim 1, wherein the at least one catalyst element comprises at least one movable catalyst element disposed on the rotary filter.

5. The aqueous effluent treatment device according to claim 1, further comprising at least one outlet portion of the treated aqueous effluents, the at least one UV lamp and/or the at least one catalyst element being fixed in the tank on the side of the outlet portion.

6. The aqueous effluent treatment device according to claim 5, the at least one outlet portion being disposed on an edge of the tank, on an axis parallel to the axis of rotation of the rotary filter.

7. The aqueous effluent treatment device according to claim 5, comprising a single outlet portion, the rotary filter being arranged in the tank so that a portion of the rotary filter enters the aqueous effluents on the side of the outlet portion when the rotary filter is rotating in the tank.

8. The aqueous effluent treatment device according to claim 1, wherein the rotary filter is arranged to be rotated sequentially.

9. The aqueous effluent treatment device according to claim 1, wherein the rotary filter is a drum filter or a disc filter or a screen filter.

10. A method for treating aqueous effluents by means of a treatment device comprising a tank, a rotary filter, at least one UV lamp and at least one catalyst element, the method comprising the following steps:
a) supplying aqueous effluents to an interior of the rotary filter,
b) rotating the rotary filter,
c) illuminating the filtered aqueous effluents by the at least one UV lamp,
d) generating ozone in the filtered aqueous effluents by the illumination of the at least one catalyst element by the at least one UV lamp.

11. The method for treating aqueous effluent according to claim 10, wherein the at least one catalyst element comprises titanium oxide and/or zinc oxide.

12. The method for treating aqueous effluent according to the claim 10, wherein the at least one catalyst element comprises at least two movable catalyst elements placed on the rotary filter, and the step of rotating the rotary filter is carried out sequentially by alternating a mobile phase and a stationary phase, so that at least one of the movable catalyst elements is always immersed and illuminated in the filtered aqueous effluent.
